(19) United States
(12) Patent Application Publication
(10) Pub. No.: US 2025/0311663 A1
(43) Pub. Date: Oct. 9, 2025

(54) APPARATUS FOR DELIVERING AN ADDITIVE TO AN IRRIGATION SYSTEM

(71) Applicant: KORREL KUNS (PTY) LTD, INGOGO (ZA)

(72) Inventor: THEUNIS JACOBUS NEL, INGOGO (ZA)

(21) Appl. No.: 19/169,446

(22) Filed: Apr. 3, 2025

(30) Foreign Application Priority Data
Apr. 3, 2024 (ZA) 2024/02573

(51) Int. Cl. A01C 23/04; A01C 21/00; A01C 23/00; A01M 7/00

(52) U.S. Cl. CPC A01C 23/042; A01C 21/007; A01C 23/007; A01M 7/0032; A01M 7/0089

(57) ABSTRACT

An apparatus and a method for delivering an additive at a predetermined flow rate to an irrigation system, the apparatus including a source of an additive, a header tank for receiving the additive, a first pump for delivering a supply of the additive from the source to the header tank, a mixing vessel, an overflow outlet from the header tank for discharging excess additive from the header tank back to the source, so that the additive in the header tank establishes a constant head a dispensing outlet from the header tank through which, under the action of the constant head, the additive is dispensed at a constant predetermined rate into a mixing vessel, for mixing with water to form a mixture, and a second pump for pumping the mixture at a predetermined rate to the irrigation system.

### BACKGROUND OF THE INVENTION

This invention relates generally to fertigation. In particular, the invention relates to an apparatus for delivering an additive at a predetermined flow rate to an irrigation system.

Additives such as water-soluble fertilizer, insecticide, herbicide, pest repellent and others are often added to water and delivered through irrigation systems for ease of treating agricultural land. The additive targets for each crop (e.g., the amount of fertilizer and the schedule for applying the fertilizer) must be controlled to ensure crop health and to avoid waste. In this regard, for a given area of land to be treated with an additive, the irrigation hours and timing for the irrigation system are determined. From there, the flow rate of the additive i.e. the number of litres of additive required per hour, for delivery to the irrigation system is calculated. Typically, use of a flow meter and specific pump settings are required to ensure the correct delivery of the additive to the irrigation system.

The use of such equipment is however not without disadvantages. The flow meters are susceptible to blockages and corrosion and require monitoring to ensure proper operation. Complex systems are also susceptible to faults.

The invention aims, to address the aforementioned issues.

### SUMMARY OF INVENTION

“Additive”, as used herein, refers to any fluid additive. The fluid additive may be of any suitable kind e.g. a fertilizer, fertilizer enhancement, inoculant, plant-growth regulator, insecticide, herbicide, trace elements and pest repellent. This is not limiting.

“Irrigation system”, as used herein, refers to any pressurised irrigation system e.g. centre pivot, travelling gun irrigator and the like.

The invention is based on the premise that an irrigation system, of the kind referred to, operating in a controlled manner, irrespective of the volume of water dispensed, traverses a section of land with an area of a known size in a defined period of time—this can be expressed for example as X hectares per hour. If an additive is to be applied at the rate of Y litres per hectare, then an apparatus according to the invention may be configured to deliver to the irrigation system, the additive at a rate of X×Y litres per hour. The quantity of water delivered by the irrigation system is not matched to the rate at which the additive is delivered, for this water acts only as a carrier.

The invention provides in the first instance an apparatus for delivering an additive at a predetermined flow rate to an irrigation system, the apparatus including a source of an additive, a header tank for receiving the additive, a first pump for delivering a supply of the additive from the source to the header tank, a mixing vessel, an overflow outlet from the header tank for discharging excess additive from the header tank back to the source, so that the additive in the header tank establishes a constant head, or gravity pressure, a dispensing outlet from the header tank through which, under the action of the constant head, the additive is dispensed at a constant predetermined rate into a mixing vessel, for mixing with water to form a mixture, and a second pump for pumping the mixture at a predetermined rate to the irrigation system.

The source of additive may comprise a receiving vessel with an opening for receiving the additive. The additive may be added to the receiving vessel from a bulk, premixed additive source. The receiving vessel may include a valve e.g. a float valve in communication with the opening for controlling a level of additive within the receiving vessel.

The dispensing outlet from the header tank, e.g. an orifice, may be sized according to requirement to vary the predetermined flow rate of the additive from the dispensing outlet. The dispensing outlet may be sized in any suitable way. In one form of the invention, the dispensing outlet may be sized by attaching a formation having an orifice with a diameter of a predetermined size. The size of the orifice and the constant head, or gravity pressure, of additive above the dispensing outlet provide the constant predetermined flow rate of additive from the dispensing outlet into the mixing vessel.

A water inlet may be provided in the mixing vessel for mixing the additive with water to form the mixture. The water inlet may include a float valve for controlling a level of water within the mixing vessel. This ensures there is always enough mixture to be pumped by the second pump to the irrigation system and that it does not run dry. An equilibrium is soon reached wherein the sum of the additive flowing through the dispensing outlet into the mixing vessel, and the water added through the water inlet to the mixing vessel, equals the amount of mixture removed from the mixing vessel by the second pump.

The second pump may be a multistage centrifugal pump. The pump may operate at a constant rate, provided that the rate is higher than the rate at which the additive is dispensed from the dispensing outlet.

A calibration tank, in fluid communication with the dispensing outlet from the header tank, may be provided to ensure that the correct flow rate of the additive is dispensed by the dispensing outlet, for any additive. Flow rates may vary according to the specific gravity or viscosity of the additive and calibration checks must be done for each different additive. The calibration tank may be of a predetermined volume.

The apparatus may be formed from any suitable non-corrosive material e.g. stainless steel or a suitable plastics material. This is not limiting.

The invention further extends to a method of applying an additive to a section of land of a known area which includes the steps of determining the period of time for an irrigation system to irrigate the section of land with water, determining the quantity of additive to be applied per unit area of land, calculating the total quantity of the additive to be applied to the section of the land, operating the irrigation system, adding the additive at a controlled rate per unit time to the water in the irrigation system so that the controlled rate of additive addition is maintained for said period of time and at the end of said period of time, the said total quantity of additive is depleted.

### DESCRIPTION OF THE DRAWINGS

The invention is further described by way of example with reference to the accompanying drawings in which:

FIG. 1 is a schematic view of an apparatus according to one form of the invention;

FIG. 2 is a perspective view of an apparatus according to a preferred embodiment of the invention; and

FIG. 3 is a side view, partially sectioned, of the apparatus in FIG. 2.

### DESCRIPTION OF PREFERRED EMBODIMENTS

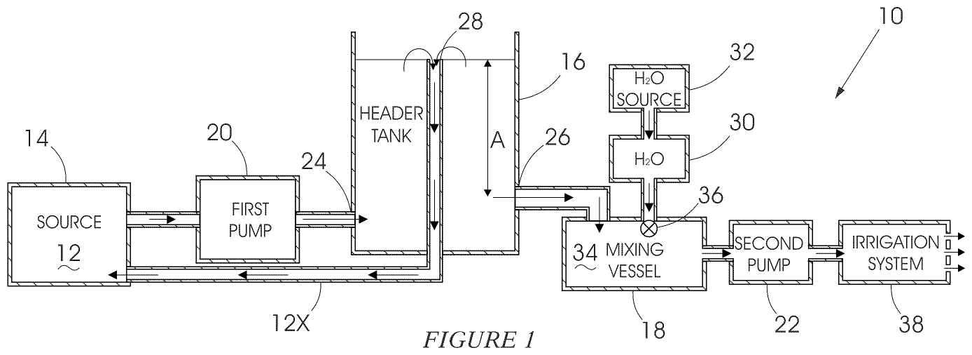

FIG. 1 of the accompanying drawings is a schematic view of an apparatus 10 according to one form of the invention. The apparatus 10 is used to deliver a predetermined flow rate (volume per time) of an additive 12 into an irrigation system. The predetermined flow rate is calculated using agronomic techniques known in the art and will not be described further herein.

The apparatus 10 includes an additive source 14 which contains the additive 12, a first pump 20, a header tank 16 for holding a quantity of the additive 12, a mixing vessel 18, and a second pump 22. The apparatus 10 is formed from any suitable non-corrosive material e.g. stainless steel or plastic.

The header tank 16 includes an inlet 24, a dispensing outlet 26 for dispensing the additive 12 from the header tank 16 and an overflow outlet 28. The first pump 20 pumps the additive 12 from the source 14 to header tank 16 through the inlet 24. The additive 12 is delivered from the source 14 to the header tank 16 by the first pump 20 such that a constant head, or gravity pressure, of the additive 12 is established in the header tank, as shown by the arrow A. Excess additive 12X is dispensed from the header tank 16 through the overflow outlet 28 and is returned to the source 14. The first pump 20 should pump additive at such a rate that more additive is supplied to the header tank than what is dispensed by the dispensing outlet 26. The contact head is conveniently generated by gravity action, simply by ensuring the header tank 16 is full.

Under the action of the constant head, or gravity pressure, the additive 12 flows from the header tank 16 through the dispensing outlet 26 into the mixing vessel 18. The constant head ensures that a constant pressure, and hence flow, of additive is maintained at the dispensing outlet 26 thereby ensuring that the additive 12 flows from the dispensing outlet 26 at a predetermined flow rate. The dispensing outlet 26 is sized according to requirement to vary the predetermined flow rate, as required. In one form of the invention, this is achieved by attaching an orifice (not shown) of a predetermined size to the dispensing outlet 26.

In the mixing vessel 18, the additive is mixed with water 30 from a water source 32, either supplied by a high-pressure side of an irrigation system 38 or drawn from another source to provide a carrier for the additive, thereby providing a mixture 34. A float valve 36 is in fluid communication with the water source 32 to control the level of the mixture 34 within the mixing vessel 18. The second pump 22 pumps the mixture 34 from mixing vessel 18 at a predetermined flow rate to an irrigation system 38. An equilibrium is soon reached wherein the sum of the additive 12 flowing from the dispensing outlet 26 into the mixing vessel 18, and the water 30 flowing from the water source 32 into the mixing vessel 18, equals the amount of mixture 34 removed from the mixing vessel 18 by the second pump 22.

The pumps 20, 22 are controlled as appropriate by any suitable switchgear, not shown. The pumps 20, 22 are submersible and are self-priming. The additive source 14 and the mixing vessel 18 include respective drainage outlets, not shown.

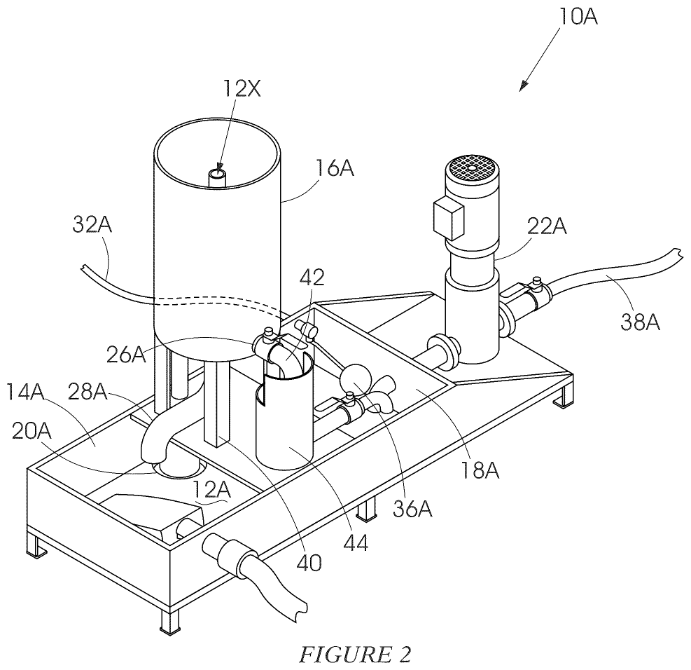

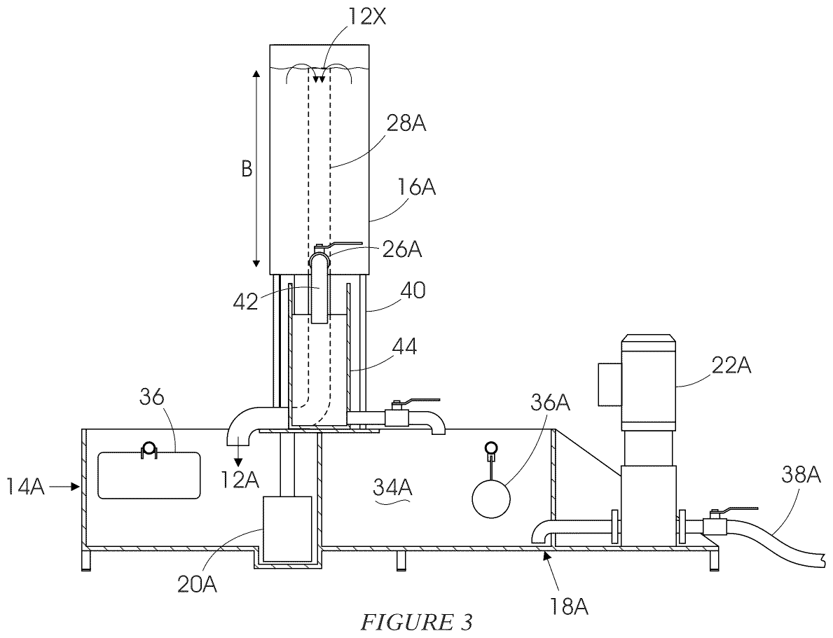

FIGS. 2 and 3 illustrate an apparatus according to a preferred embodiment of the invention. The apparatus 10A operates according to the principles of the invention and for this reason like numerals will be used to designate like features. The apparatus 10A includes an additive source in the form of a receiving vessel 14A for receiving an additive 12A, a header tank 16A, a first pump 20A, a mixing vessel 18A and a second pump 22A.

The header tank 16A is supported at an elevated position relative to the receiving vessel 14A and the mixing vessel 18A by support structure 40. The apparatus 10A is provided as a single unit for ease of portability.

The additive 12A is delivered from the receiving vessel 14A to the header tank 16A by the first pump 20A such that a constant head, or gravity pressure, of the additive 12A is established in the header tank, as shown by the arrow B. Excess additive 12X is dispensed from the header tank 16A through an overflow outlet 28A and is returned to the source 14A. The overflow outlet 28A is in the form of a drop inlet pipe or column, positioned within the header tank 16A at a specific height above the dispensing outlet 26A.

Under the action of the constant head, or gravity pressure, the additive 12A flows from the header tank 16A through the dispensing outlet 26A at a predetermined flow rate into the mixing vessel 18A. The dispensing outlet 26A is sized according to requirement to vary the predetermined flow rate, as required. This is achieved by attaching an orifice 42 of a predetermined size to the dispensing outlet 26A. The additive 12A is replenished, if needed, by means of a suitable valve, not shown.

In the mixing vessel 18A, the additive 12A is mixed with water from a water source 32A to provide a carrier for the additive, thereby to provide a mixture 34A. A float valve 36A in fluid communication with the water source 32A controls the level of the mixture 34A within the mixing vessel 18A. The second pump 22A, in the form of a centrifugal pump, pumps the mixture 34A from the mixing vessel 18A at a predetermined flow rate to an irrigation system 38A. An equilibrium is soon reached wherein the amount of additive 12A flowing through the dispensing outlet 26A and the amount of water which is added to the mixing vessel 18A and controlled by the float valve 36A, equals the amount of mixture 34A removed from the mixing vessel 18A by the second pump 22A.

For additives with varying viscosity, a calibration tank 44 is provided. The calibration tank 44 is used to ensure that the correct flow rate of the additive through the dispensing outlet 26A is achieved. The flow rate is varied by fitting an orifice 42 of a predetermined size to the dispensing outlet to achieve the predetermined flow rate. The calibration is performed using known techniques.

The apparatus according to the invention provides a simple and efficient way to control the flow rate of an additive for use in an irrigation system. Once the predetermined flow rate is calculated and the dispensing outlet has been sized accordingly, the apparatus does not require further monitoring. As water is used as a carrier, the apparatus also does not require an exact determination and control of the ratio of water to additive to be added, which requires the use of complex and expensive equipment.

The drawings herein are by example only and do not limit the scope of the invention.

1. An apparatus for delivering an additive at a predetermined flow rate to an irrigation system, the apparatus including a source of an additive, a header tank for receiving the additive, a first pump for delivering a supply of the additive from the source to the header tank, a mixing vessel, an overflow outlet from the header tank for discharging excess additive from the header tank back to the source, so that the additive in the header tank establishes a constant head a dispensing outlet from the header tank through which, under the action of the constant head, the additive is dispensed at a constant predetermined rate into a mixing vessel, for mixing with water to form a mixture, and a second pump for pumping the mixture at a predetermined rate to the irrigation system.

2. An apparatus according to claim 1 wherein the source of additive comprises a receiving vessel with an opening for receiving the additive which is added to the receiving vessel from a bulk, premixed additive source and a valve in communication with the opening for controlling a level of additive within the receiving vessel.

3. An apparatus according to claim 1 wherein the dispensing outlet includes an orifice which is sized to vary the predetermined flow rate of the additive from the dispensing outlet, such that the size of the orifice and the constant head of additive above the dispensing outlet provide said constant predetermined flow rate of additive from the dispensing outlet into the mixing vessel.

4. An apparatus according to claim 1 wherein a water inlet which includes a valve is provided in the mixing vessel for mixing the additive with water to form the mixture, wherein the valve is configured to control a level of water within the mixing vessel to ensure that there is always enough mixture to be pumped by the second pump to the irrigation system and that it does not run dry whereby an equilibrium is reached when the sum of the additive flowing through the dispensing outlet into the mixing vessel, and of the water added through the water inlet to the mixing vessel, equals the amount of mixture removed from the mixing vessel by the second pump.

5. An apparatus according to claim 1 wherein the second pump is a multistage centrifugal pump which is operate at a constant rate, which is higher than the rate at which the additive is dispensed from the dispensing outlet.

6. An apparatus according to claim 1 which includes a calibration tank, in fluid communication with the dispensing outlet from the header tank, which is configured to ensure that the additive is dispensed at said predetermined rate.

7. A method of applying an additive to a section of land of a known area which includes the steps of determining the period of time for an irrigation system to irrigate the section of land with water, determining the quantity of additive to be applied per unit area of land, calculating the total quantity of the additive to be applied to the section of the land, operating the irrigation system, adding the additive at a controlled rate per unit time to the water in the irrigation system so that the controlled rate of additive addition is maintained for said period of time and at the end of said period of time, the said total quantity of additive is depleted.
